(19) United States
(12) Patent Application Publication
(10) Pub. No.: US 2026/0155596 A1
(43) Pub. Date: Jun. 4, 2026

(54) POWER CONNECTOR

(71) Applicant: Bellwether Electronic (Kunshan) Co., Ltd., Jiangsu (CN)

(72) Inventors: Li-Yong BAI, Jiangsu (CN); Honghao WANG, Jiangsu (CN)

(21) Appl. No.: 19/214,056

(22) Filed: May 21, 2025

(30) Foreign Application Priority Data
Dec. 3, 2024 (CN) 202411774122.6

(51) Int. Cl. H01R 13/428; H01R 13/26; H01R 13/512; H01R 13/533; H01R 103/00

(52) U.S. Cl. CPC H01R 13/428; H01R 13/26; H01R 13/512; H01R 13/533; H01R 2103/00

(57) ABSTRACT

A power connector includes two electrode assemblies, a housing and two locking pieces. The two electrode assemblies each include a busbar and a terminal fixedly attached to the busbar. The housing includes two sidewalls and a mating portion. The two sidewalls are spaced apart from each other and collectively define an accommodating space. The mating portion is connected to the sidewalls and projects from one side of the sidewalls. The mating portion defines a slot normal to the sidewalls. The busbars of the two electrode assemblies are disposed in the accommodating space and are spaced apart from each other. The terminal partially extends into the slot of the mating portion. The two locking pieces are affixed to the busbar of the two electrode assemblies, respectively. The two sidewalls of the housing each include at least one recess. The locking pieces fixedly engage the recess.

### RELATED APPLICATIONS

This application claims priority to China Application Serial Number 202411774122.6, filed Dec. 3, 2024, the disclosure of which is incorporated herein by reference in its entirety.

### BACKGROUND

### Technical Field

The present disclosure relates to a power connector.

### Description of Related Art

As technology advances, computer servers have increasingly higher demand for electric power. Therefore, the industry is in urgent need of a solution for improving power connectors such that power connectors can carry larger electric current and dissipate heat at higher rate.

### SUMMARY

In view of the foregoing, one of the objects of the present disclosure is to provide an improved power connector to resolve the technical problem mentioned above.

In accordance with an embodiment of the present disclosure, a power connector includes two electrode assemblies, a housing and two locking pieces. The two electrode assemblies each include at least one terminal and at least one busbar. The terminal is fixedly attached to the busbar. The housing includes two sidewalls and a mating portion. The two sidewalls are spaced apart from each other and collectively define an accommodating space. The mating portion is connected to the two sidewalls and projects from one side of the two sidewalls. The mating portion defines a slot substantially normal to the two sidewalls. The busbar is disposed in the accommodating space. The busbar of a first electrode assembly of the two electrode assemblies is spaced apart from the busbar of a second electrode assembly of the two electrode assemblies. The terminal partially extends into the slot of the mating portion. The two locking pieces are affixed to the busbars of the first electrode assembly and the second electrode assembly, respectively. The two sidewalls each have at least one recess, and the two locking pieces fixedly engage the recess of each of the two sidewalls.

In one or more embodiments of the present disclosure, the two locking pieces each include a latch structure. The two sidewalls include a stopper structure. The stopper structure is located on a side of the latch structure away from the mating portion and engages the latch structure.

In one or more embodiments of the present disclosure, the stopper structure has the recess. The recess is formed on a side of the stopper structure away from the latch structure.

In one or more embodiments of the present disclosure, the latch structure has a leading edge extending obliquely in a direction away from the mating portion. The stopper structure has a sloping surface corresponding to the leading edge of the latch structure. The sloping surface and the leading edge have complementary shapes.

In one or more embodiments of the present disclosure, the latch structure includes a flexible arm structure extending in an oblique direction.

In one or more embodiments of the present disclosure, the stopper structure includes a bump. The bump has a sloping surface extending in the oblique direction.

In one or more embodiments of the present disclosure, the two sidewalls of the housing further define a first side opening and a second side opening. The first side opening and the second side opening are located on two opposite sides of the accommodating space. The two locking pieces extend across the first side opening and the second side opening, respectively, and fixedly engage each of the two sidewalls.

In one or more embodiments of the present disclosure, the recess of a first sidewall of the two sidewalls and the recess of a second sidewall of the two sidewalls are located on two sides of the first side opening. One of the two locking pieces includes two extension arms, one of which is fixedly inserted into the recess of the first sidewall and the other is fixedly inserted into the recess of the second sidewall.

In one or more embodiments of the present disclosure, the two extension arms each include a hook portion fixedly engaging the recess.

In one or more embodiments of the present disclosure, the two electrode assemblies keep a gap in between. The gap is void of any object that electrically isolates the two electrode assemblies. The gap communicates with the slot to form an airflow passage.

In one or more embodiments of the present disclosure, the busbar of each of the two electrode assemblies includes a first conductive block, a second conductive block and a braided conductive wire structure. The first conductive block is fixedly attached the terminal. The second conductive block is disposed outside the housing. The braided conductive wire structure is connected between the first conductive block and the second conductive block.

In one or more embodiments of the present disclosure, the at least one terminal includes a first terminal and a second terminal. The first terminal, the second terminal and the first conductive block are in a stack arrangement. The first terminal and the second terminal each include a contact portion. The contact portion of the first terminal is positioned behind the contact portion of the second terminal in an extending direction of the mating portion.

In one or more embodiments of the present disclosure, the contact portion of the first terminal is aligned with the contact portion of the second terminal in a third direction normal to the extending direction of the mating portion.

In one or more embodiments of the present disclosure, an orientation of the first conductive block is normal to an orientation of the second conductive block.

In one or more embodiments of the present disclosure, the mating portion includes two standing walls spaced apart from each other, such that the slot is formed between the two standing walls. An inner surface of the first conductive block of the first electrode assembly is substantially flush with an inner surface of one of the two standing walls. An inner surface of the first conductive block of the second electrode assembly is substantially flush with an inner surface of another one of the two standing walls.

In one or more embodiments of the present disclosure, the two sidewalls each have at least one guiding groove. The guiding grooves are located on inner surfaces of the two sidewalls and extend along an extending direction of the mating portion. An edge of the terminal is received by the guiding groove.

In one or more embodiments of the present disclosure, the two sidewalls each have a first edge, a second edge opposite to the first edge, and a third edge connected between the first edge and the second edge. The recess of each of the two sidewalls is plural in number. The recesses of each of the two sidewalls are located on the first edge and the second edge.

In one or more embodiments of the present disclosure, the recesses of the two sidewalls are located on inner surfaces of the two sidewalls.

In one or more embodiments of the present disclosure, the busbar includes at least one copper busbar.

In one or more embodiments of the present disclosure, the busbar is plural in number, and the two locking pieces are fixed between two of the busbars.

In sum, in the power connector of the present disclosure, each electrode assembly includes at least one terminal and a conductive block (e.g., a copper block) in contact with the terminal to widen the path of electric current and enable the power connector to carry larger current. As for the design of the housing, the main body of the housing only includes two sidewalls. The two sidewalls are normal to two standing walls of the mating portion. The two sidewalls are spaced apart from each other and are not interconnected by any partitioning wall (i.e., the space between the two electrode assemblies is void of any object that electrically isolates the two electrode assemblies). As a result, larger copper blocks can be placed in the housing, and the gap between the copper blocks of the two electrode assemblies can act as an airflow passage to facilitate cooling of the copper blocks and the terminals, which electric current flows through. A locking piece is attached to each copper block. The locking piece includes a latch structure that engages a corresponding stopper structure of the housing to prevent the copper blocks and the terminals from separating with the housing. The locking piece does not impose any limitation on the thickness of the copper block. Consequently, the thickness, and correspondingly, the current carrying capacity, of the copper block can be adjusted for different use cases freely.

### BRIEF DESCRIPTION OF THE DRAWINGS

To make the objectives, features, advantages, and embodiments of the present disclosure, including those mentioned above and others, more comprehensible, descriptions of the accompanying drawings are provided as follows.

FIG. 1 illustrates an isometric view of a power connector and a power rail in accordance with an embodiment of the present disclosure;

FIG. 2 illustrates a sectional view of the power connector and the power rail shown in FIG. 1, with the power connector being connected to the power rail;

FIG. 3 illustrates an exploded view of the power connector shown in FIG. 1;

FIG. 4 illustrates a partially enlarged view of the power connector shown in FIG. 1;

FIG. 5 illustrates an axonometric view of a power connector in accordance with another embodiment of the present disclosure; and

FIG. 6 illustrates a side view of a power connector in accordance with another embodiment of the present disclosure.

### DETAILED DESCRIPTION

For the completeness of the description of the present disclosure, reference is made to the accompanying drawings and the various embodiments described below. Various features in the drawings are not drawn to scale and are provided for illustration purposes only. To provide full understanding of the present disclosure, various practical details will be explained in the following descriptions. However, a person with an ordinary skill in relevant art should realize that the present disclosure can be implemented without one or more of the practical details. Therefore, the present disclosure is not to be limited by these details.

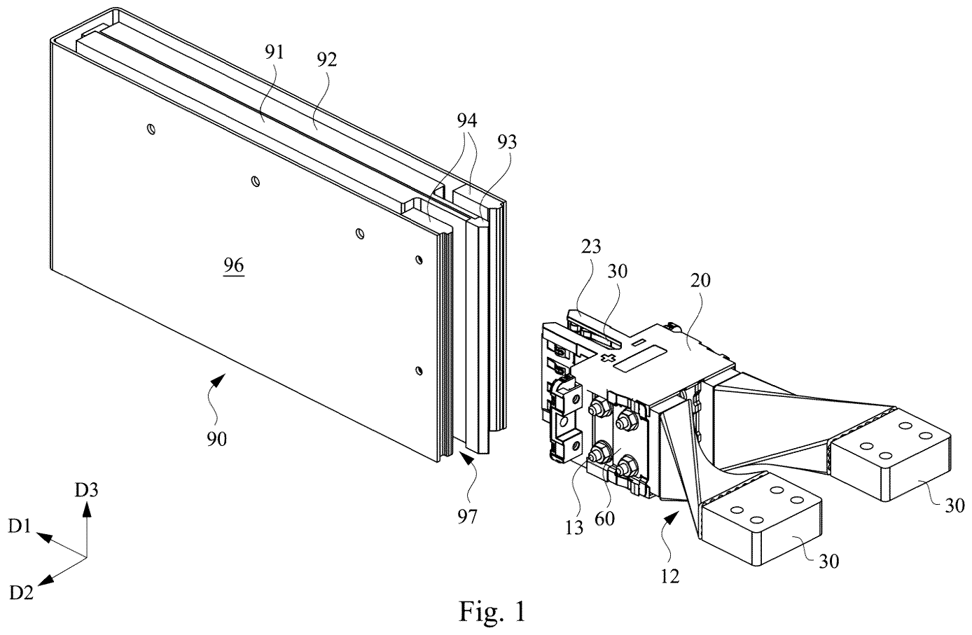

Reference is made to FIG. 1. FIG. 1 illustrates an isometric view of a power connector 12 and a power rail 90 (also known as “rack busbar”) in accordance with an embodiment of the present disclosure. The power connector 12 is, for example, a busbar clip connector. In practice, the power rail 90 can be connected to a power source (e.g., a DC power source), and the power connector 12 can be mounted in a server and coupled to the power rail 90, such that the power rail 90 can deliver electric power to the server via the power connector 12. FIG. 1 shows a simplified view of the power rail 90. In practice, the power rail 90 may have an elongated shape and extend in a vertical direction, such that the power rail 90 can deliver electric power to multiple rack servers in stack arrangement. In such cases, each of the rack servers includes the power connector 12 plugged into the power rail 90.

As shown in FIG. 1, the power rail 90 includes a housing 96 which is generally U-shaped. The power rail 90 further includes two electrodes 91 and 92, an insulation bar 93 and two grounding pads 94, all of which are disposed in the housing 96. The two electrodes 91 and 92 have shapes of flat plates and are configured to transmit different voltages. The insulation bar 93 is disposed between the two electrodes 91 and 92 and electrically isolates the two electrodes 91 and 92. The housing 96 has an insertion opening 97. The two electrodes 91 and 92, the insulation bar 93 and the two grounding pads 94 are exposed by the insertion opening 97. The two electrodes 91 and 92 and the insulation bar 93 are fixedly installed at the center of the housing 96. The two grounding pads 94 are fixedly mounted on two sidewalls of the housing 96, respectively.

As shown in FIG. 1, the power connector 12 includes a housing 20 and two electrode assemblies 30. The housing 20 includes a mating portion 23. The mating portion 23 projects from a front side of the housing 20 and is configured to mate with the power rail 90. The two electrode assemblies 30 are configured to transmit electric current. The two electrode assemblies 30 can represent a positive electrode and a negative electrode, respectively. The two electrode assemblies 30 are spaced apart from each other, i.e., the two electrode assemblies 30 do not make contact with each other. A part of each electrode assembly 30 is disposed in the mating portion 23 of the housing 20 to make contact with the electrodes 91 and 92 of the power rail 90. A part of each electrode assembly 30 extends out of the housing 20 from a rear side of the housing 20 to be connected to one or more electronic components of the server (not depicted). The power connector 12 further includes two locking pieces 60 disposed on two opposite sides of the housing 20 (only one of the two locking pieces 60 is shown in FIG. 1). The two locking pieces 60 are connected to the two electrode assemblies 30, respectively, and the two locking pieces 60 are also connected to the housing 20. The two locking pieces 60 serve to prevent the two electrode assemblies 30 from separating with the housing 20. In some embodiments, the housing 20 includes electrically insulative material. In some embodiments, the locking pieces 60 include metal material.

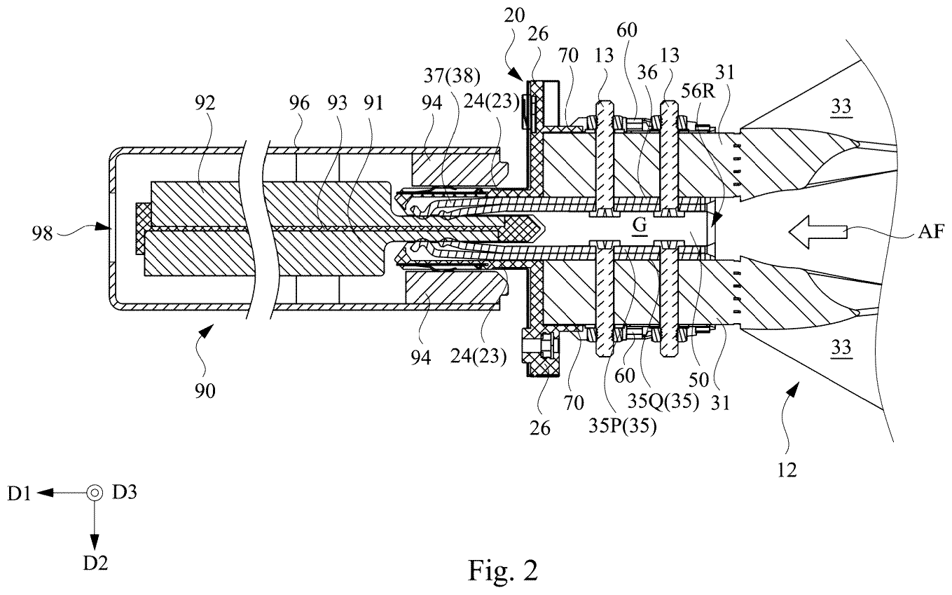

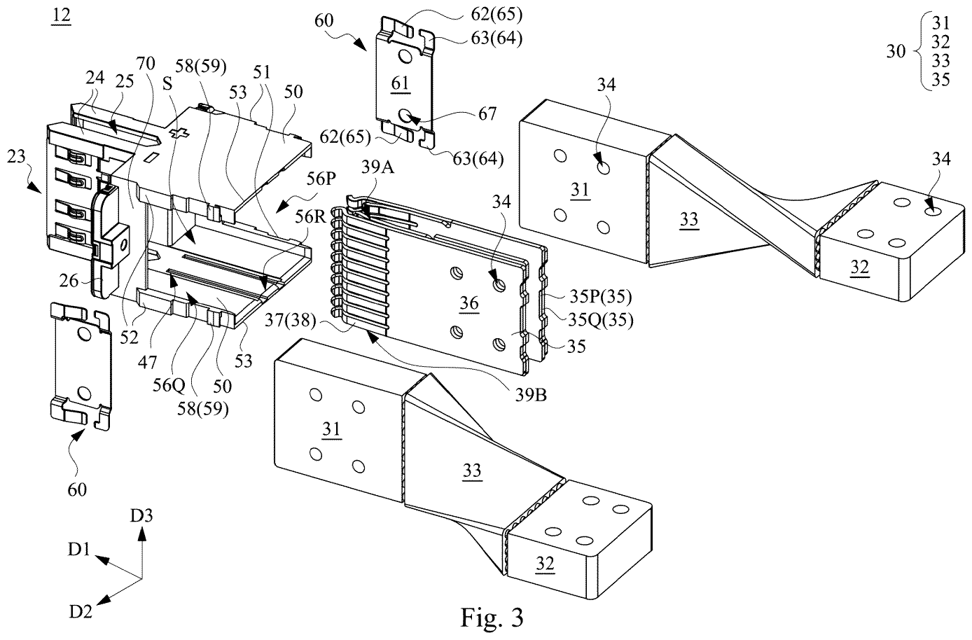

Reference is made to FIGS. 2 and 3. FIG. 2 illustrates a sectional view of the power connector 12 and the power rail 90 shown in FIG. 1, with the power connector 12 being connected to the power rail 90. FIG. 3 illustrates an exploded view of the power connector 12 shown in FIG. 1 (fasteners 13 are omitted). As shown, the mating portion 23 defines a slot 25. The slot 25 is configured to receive the two electrodes 91 and 92 and the insulation bar 93 of the power rail 90. Specifically, the mating portion 23 includes two standing walls 24 spaced apart from each other, such that the slot 25 is formed between the two standing walls 24. Each of the two electrode assemblies 30 includes at least one terminal 35 partially extending into the slot 25. The terminals 35 of the two electrode assemblies 30 are disposed on two sides of the slot 25, respectively, and are configured to make contact with the two electrodes 91 and 92 of the power rail 90, respectively. The two standing walls 24 of the mating portion 23 extend along a first direction D1. The two standing walls 24 are arranged side by side in a second direction D2, which is substantially normal to the first direction D1.

As shown in FIGS. 2 and 3, the housing 20 further includes two sidewalls 50. The two sidewalls 50 are arranged side by side in a third direction D3. The third direction D3 is substantially normal to the first direction D1 and the second direction D2. In other words, the two sidewalls 50 are substantially normal to the two standing walls 24 (and the slot 25). The two sidewalls 50 are spaced apart from each other and collectively define an accommodating space S. The mating portion 23 is connected to the two sidewalls 50 and projects from one side of the two sidewalls 50. Each of the two electrode assemblies 30 further includes at least one busbar electrically connected to the terminal 35 and the one or more electronic components of the server (e.g., the server may include an electrical connector coupled to the busbar). The busbar may be a rigid busbar or a flexible busbar. Each busbar includes a first connection portion, which is, for example, a first conductive block 31 shown in the drawings. The first conductive block 31 may be generally rectangular. The first conductive blocks 31 of the two electrode assemblies 30 are arranged side by side in the second direction D2. The first conductive blocks 31 of the two electrode assemblies 30 are disposed in the accommodating space S and are spaced apart from each other, i.e., the first conductive blocks 31 of the two electrode assemblies 30 (or the busbars of the two electrode assemblies 30 in general) do not make contact with each other. In some embodiments, the first conductive blocks 31 of the two electrode assemblies 30 keep a gap in between, and the gap is aligned with the slot 25. In some embodiments, an inner surface of the first conductive block 31 is substantially flush with an inner surface of a respective standing wall 24 of the mating portion 23.

As shown in FIGS. 2 and 3, in some embodiments, each terminal 35 includes a plate portion 36 and a contact portion 37 connected to the plate portion 36. The plate portion 36 is disposed in the accommodating space S and is fixedly attached to the inner surface of a respective first conductive block 31. For example, the plate portion 36 may be disposed in the gap between the first conductive blocks 31 of the two electrode assemblies 30. The contact portion 37 is disposed in the mating portion 23 and is configured to make contact with the electrodes 91 and 92 of the power rail 90. The contact portion 37 may include a plurality of beams 38. The beams 38 are linearly arranged along the third direction D3, and any two adjacent beams keep a gap in between. The beams 38 are flexible such that the beams 38 can tightly contact the electrodes 91 and 92 of the power rail 90.

As shown in FIGS. 2 and 3, in some embodiments, the terminal 35 and the corresponding first conductive block 31 can be fixedly held together by one or more fasteners 13 (e.g., bolt). The plate portion 36 of the terminal 35 and the first conductive block 31 each have one or more through holes 34. The fasteners 13 can pass through the through holes 34. In other embodiments, the terminal 35 and the corresponding first conductive block 31 can be fixedly joined by ultrasonic welding or other suitable means.

As shown in FIGS. 2 and 3, the two sidewalls 50 each have a first edge 51, a second edge 52 opposite to the first edge 51, and a third edge 53 connected between the first edge 51 and the second edge 52. The third edge 53 is located on a side of the sidewall 50 away from the mating portion 23. The two sidewalls 50 further define a first side opening 56P located between the first edges 51 of the two sidewalls 50, a second side opening 56Q located between the second edges 52 of the two sidewalls 50, and a rear opening 56R located between the third edges 53 of the two sidewalls 50. Outer surfaces of the first conductive blocks 31 of the two electrode assemblies 30 can face the first side opening 56P and the second side opening 56Q, respectively. In some embodiments, the first conductive block 31 partially extends out of the housing 20 via either the first side opening 56P, the second side opening 56Q or the rear opening 56R. For example, in the present embodiment, the first conductive block 31 partially extends out of the housing 20 via the rear opening 56R.

As shown in FIGS. 2 and 3, in some embodiments, the housing 20 further includes two wings 26. Each wing 26 is connected between a respective standing wall and a respective sidewall 50. The wings 26 are generally normal to the standing walls 24 of the mating portion 23 and the sidewalls 50. Each standing wall 24 and an adjacent wing 26 form an L-shaped structure. In the second direction D2, a total width of the two wings 26 is greater than a width of each one of the two sidewalls 50. In other words, the two wings 26 laterally extend beyond the two sidewalls 50 in the second direction D2.

As shown in FIGS. 2 and 3, in some embodiments, each busbar further includes a second connection portion, which is, for example, a second conductive block 32 shown in the drawings. In some embodiments, the first connection portion (e.g., the first conductive block 31) and the second connection portion (e.g., the second conductive block 32) are interconnected by a braided conductive wire structure 33. In some embodiments, the busbar is a copper busbar. The first connection portion and the second connection portion are provided on two opposite ends of the copper busbar. The second conductive block 32 is disposed outside the housing 20 and is configured to be connected to the electronic components of the server. The second conductive block 32 may have one or more through holes 34, which allows the second conductive block 32 to be affixed to the electronic components of the server via additional fasteners (not depicted). The first conductive block 31 and the second conductive block 32 are rigid, whereas the braided conductive wire structure 33 is flexible, i.e., can be twisted or bent, which facilitates positioning the second conductive block 32 differently for systems (e.g., servers) having different designs. In some embodiments, an orientation of the first conductive block 31 is normal to an orientation of the second conductive block 32. The orientation of the first or second conductive block may be defined as the normal direction of the largest surface of the first or second conductive block. In the illustrated embodiment, the orientation of the first conductive block 31 is the second direction D2, and the orientation of the second conductive block 32 is the third direction D3. The various components of the two electrode assemblies 30 may include copper or other suitable electrically conductive materials. The braided conductive wire structure 33 may include a plurality of metal wires and an insulative cover wrapping the metal wires. Two ends of the metal wires can be fixedly joined with the first conductive block 31 and the second conductive block 32, respectively, by ultrasonic welding or other suitable means. Alternatively, two ends of the metal wires can be joined and stiffened to form the first conductive block 31 and the second conductive block 32.

As shown in FIGS. 2 and 3, in some embodiments, each electrode assembly 30 can include a first terminal 35P and a second terminal 35Q. The first terminal 35P and the second terminal 35Q both have the plate portion 36. The plate portions 36 of the first terminal 35P and the second terminal 35Q and a respective first conductive block 31 are in a stack arrangement. The contact portion 37 of the first terminal 35P is positioned behind the contact portion 37 of the second terminal 35Q in the first direction D1. For example, a distance from the contact portion 37 of the first terminal 35P to an outer end of the mating portion 23 is greater than a distance from the contact portion 37 of the second terminal 35Q to the outer end of the mating portion 23.

As shown in FIGS. 2 and 3, in some embodiments, the contact portion 37 of the first terminal 35P is aligned with the contact portion 37 of the second terminal 35Q in the third direction D3. In some embodiments, the contact portion 37 of the first terminal 35P and the contact portion 37 of the second terminal 35Q each have two edges 39A and 39B, and the two edges 39A and 39B are opposite to each other in the third direction D3. The edge 39A of the first terminal 35P and the edge 39A of the second terminal 35Q are aligned with each other. The edge 39B of the first terminal 35P and the edge 39B of the second terminal 35Q are aligned with each other. In some embodiments, in the third direction D3, a ratio of a sum of widths of all beams 38 of the first terminal 35P to a maximum width of the contact portion 37 of the first terminal 35P (e.g., the distance between the two edges 39A and 39B) is greater than or equal to 0.5. Moreover, in the third direction D3, a ratio of a sum of widths of all beams 38 of the second terminal 35Q to a maximum width of the contact portion 37 of the second terminal 35Q can also be greater than or equal to 0.5.

As shown in FIGS. 2 and 3, in some embodiments, the two electrode assemblies 30 keep a gap G in between. More particularly, the gap G is located between the plate portions 36 of the terminals 35 of the two electrode assemblies 30. The gap G is void of any object that electrically isolates the two electrode assemblies 30. The gap G communicates with the slot 25 of the mating portion 23 to form an airflow passage. When the power connector 12 is mounted in the server, an airflow AF generated by a fan of the server can pass through the rear opening 56R of the housing 20, the gap G, the slot 25 of the mating portion 23, the gaps between the beams 38 of the terminals 35, and an internal space of the housing 96 of the power rail 90. The airflow AF can help the electrode assemblies 30 of the power connector 12 and the electrodes 91 and 92 of the power rail 90 dissipate heat to maintain normal and stable power delivery. In some embodiments, a rear wall of the housing 96 of the power rail 90 has one or more vents 98 through which the airflow AF can be discharged.

In some embodiments, the housing 20 further includes two short sidewalls 70. Each of the two short sidewalls 70 extends from a respective wing 26 and is perpendicular to the respective wing 26. Each of the two short sidewalls 70 is connected between portions of same edges (the first edges 51 or the second edges 52) of the two sidewalls 50 away from the third edges 53. In the first direction D1, a length of the short sidewall 70 is shorter than that of the sidewall 50. The first side opening 56P is located between the first edges 51 of the two sidewalls 50 and adjoins one of the two short sidewalls 70. The second side opening 56Q is located between the second edges 52 of the two sidewalls 50 and adjoins the other one of the two short sidewalls 70. The two short sidewalls 70 can further strengthen the structure of the housing 20. Each of the first conductive blocks 31 may have a portion located behind (i.e., on an inner side of) a corresponding one of the two short sidewalls 70.

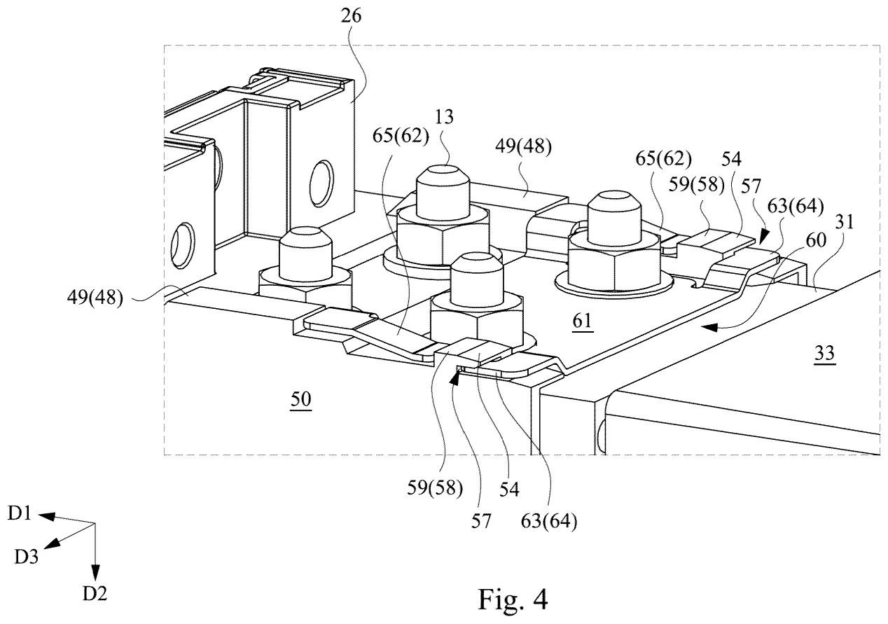

Reference is made additionally to FIG. 4. FIG. 4 illustrates a partially enlarged view of the power connector 12 shown in FIG. 1. As shown in FIGS. 3 and 4, the two locking pieces 60 extend across the first side opening 56P and the second side opening 56Q of the housing 20, respectively, and fixedly engage each of the two sidewalls 50 of the housing 20. In addition, each locking piece 60 is affixed to an outer side of the first conductive block 31 of a respective electrode assembly 30. In some embodiments, each electrode assembly 30 can include multiple busbars. Each locking piece 60 may be fixed to outer sides of the first conductive blocks 31 of the multiple busbars, or may be fixed between the first conductive blocks 31 of two of the busbars. In the latter case, the locking piece 60 is electrically conductive and can electrically connect the multiple busbars of the same electrode assembly 30. In some embodiments, the locking piece 60 includes a base portion 61, the base portion 61 abutting the first conductive block 31. The base portion 61 may have one or more through holes 67. The fasteners 13 can pass through the through holes 67 to fixedly combine the locking piece 60, the first conductive block 31 and the terminal 35. In some embodiments, the two sidewalls 50 of the housing 20 each have at least one recess 57, and each of the two locking pieces 60 fixedly engages the recess 57 of each of the two sidewalls 50. Depending on how the locking pieces 60 and the first conductive block 31 are arranged, the recesses 57 can be provided on the first edge 51 and the second edge 52 of the two sidewalls 50, or alternatively, can be grooves located on inner surfaces of the two sidewalls 50. In other words, the position of the locking piece 60 can be adjusted based on an overall thickness of one or more first conductive blocks 31 in the second direction D2 and does not place any restriction on the thickness of the one or more first conductive blocks 31. Consequently, current carrying capacities of the busbars can be adjusted for different use cases freely. In some embodiments, each of the two locking pieces 60 includes two extension arms 63. The two extension arms 63 are connected to the base portion 61 and extend outwardly from two sides of the base portion 61. One of the two extension arms 63 is fixedly inserted into the recess 57 of one of the two sidewalls 50, and the other one of the two extension arms 63 is fixedly inserted into the recess 57 of the other one of the two sidewalls 50. By this arrangement, the locking pieces 60 can be fixed to the two sidewalls 50 (e.g., restrain movement of the locking pieces 60 in the second direction D2 to prevent them from separating with the housing 20). In some embodiments, the locking piece 60 includes at least one bent portion adjacent to the two sidewalls 50. The at least one bent portion can make the relative position of the base portion 61 either close to or away from the housing 20. For example, each bent portion may be connected between the base portion 61 and a respective extension arm 63. Each bent portion can include a first section abutting the inner surface of one of the two sidewalls 50 and a second section abutting the first edge 51 or the second edge 52 of one of the two sidewalls 50. By this arrangement, connection between the locking pieces 60 and the two sidewalls 50 can be strengthened.

As shown in FIGS. 3 and 4, each of the two locking pieces 60 may further include a latch structure 62. The latch structure 62 is connected to the base portion 61 and extends from lateral sides of the base portion 61. The two sidewalls 50 of the housing 20 include at least one first stopper structure 58. The first stopper structure 58 is located on one or more edges of the sidewalls 50 and is located on a side of the latch structure 62 away from the mating portion 23. The first stopper structure 58 engages the latch structure 62. The first stopper structure 58 can restrain movement of the locking piece 60 and the electrode assembly 30 attached thereto along an opposite direction of the first direction D1 to prevent them from detaching from the housing 20. In some embodiments, the first stopper structure 58 includes one or more bumps.

As shown in FIGS. 3 and 4, in some embodiments, the latch structure 62 includes two latches 65 disposed on two opposite sides of the base portion 61. Correspondingly, the first stopper structure 58 includes two bumps 59 disposed on the first edge 51 and the second edge 52, respectively, and each engaging a respective latch 65. In some embodiments, the two sidewalls 50 of the housing 20 may further include at least one second stopper structure 48. The latch structure 62 is located between the first stopper structure 58 and the second stopper structure 48. The second stopper structure 48 can restrain movement of the locking piece 60 along the first direction D1. In some embodiments, the second stopper structure 48 includes two bumps 49 disposed on the first edge 51 and the second edge 52, respectively. Each latch 65 is disposed between a respective bump 59 and a respective bump 49.

As shown in FIGS. 3 and 4, in some embodiments, at least one of the two latches 65 includes a flexible arm structure extending in an oblique direction. Due to tolerances, mechanical parts have size variations. The flexible arm structure can help deal with the size variations and facilitate assembly of the power connector 12. Furthermore, the flexible arm structure enables the locking piece 60 to be attached to the housing 20 by a sliding operation. In some embodiments, the flexible arm structure extends towards the opposite direction of the first direction D1 and extends inwardly towards a respective sidewall 50. In some embodiments, a method for assembling the power connector 12 includes: (1) combining two sets of the terminal 35, the first conductive block 31 and the locking piece 60 separately (e.g., using the fasteners 13 to hold them together); and (2) sliding the terminal 35 and the first conductive block 31 into the housing 20 along the first direction D1. After completing said steps, the latch structure 62 of each locking piece 60 engages the first stopper structure 58 of the housing 20, and thus the terminal 35 and the first conductive block 31 are prevented from detaching from the housing 20. In step (2) described above, during the sliding operation, the flexible arm structure of the latch 65 first gets pushed away by the bump 59. After the flexible arm structure passes through the bump 59, the flexible arm structure restore its shape and engages the bump 59, such that the locking piece 60 cannot be moved in the opposite direction of the first direction D1. In some embodiments, at least one of the two bumps 59 has a sloping surface 54 extending in the same oblique direction as the flexible arm structure. With the sloping surface 54, the flexible arm structure can smoothly slide past the bumps 59. In some embodiments, the two sidewalls 50 of the housing 20 each have at least one guiding groove 47. The guiding grooves 47 are located on inner surfaces of the two sidewalls 50 and extend along an extending direction of the mating portion 23 (e.g., the first direction D1). Each guiding groove 47 receives an edge of the plate portion 36 of at least one corresponding terminal 35. The plate portions 36 of the first terminal 35P and the second terminal 35Q can have equal width in the third direction D3, and the edges of the plate portions 36 of both the first terminal 35P and the second terminal 35Q can be received by the guiding grooves 47. Alternatively, the plate portions 36 of the first terminal 35P and the second terminal 35Q can have unequal width in the third direction D3. In the illustrated embodiment, the plate portion 36 of first terminal 35P, which is wider than the plate portion 36 of the second terminal 35Q, has its edges received by the guiding grooves 47, whereas the edges of the plate portion 36 of the second terminal 35Q do not enter the guiding grooves 47. During the assembly process, the guiding grooves 47 can guide the terminal 35 to accurately slide into the mating portion 23. After the power connector 12 has been assembled, the guiding grooves 47 can prevent displacement of the terminal 35.

As shown in FIGS. 3 and 4, in some embodiments, the bump 59 has the recess 57, and the recess 57 can be formed on a side of the bump 59 away from the mating portion 23 (or away from the latch structure 62). In some embodiments, each recess 57 has two openings, one of which is on a side of the bump 59 away from the mating portion 23, and the other is on a side of the bump 59 away from the base portion 61. The base portion 61 does not have any opening on a side facing the base portion 61. The two extension arms 63 of the locking piece 60 each include a hook portion 64 fixedly engaging a respective recess 57. The hook portion 64 can help strengthen the overall structure of the power connector 12. Specifically, the hook portion 64 can prevent deformation of the two sidewalls 50 when the electrode assemblies 30 (the first conductive block 31 in particular) are twisted. In some embodiments, the hook portion 64 is bent towards the latch structure 62. During the assembly process, once the latch structure 62 slides past the bump 59, the hook portion 64 also slides into and engages the corresponding recess 57.

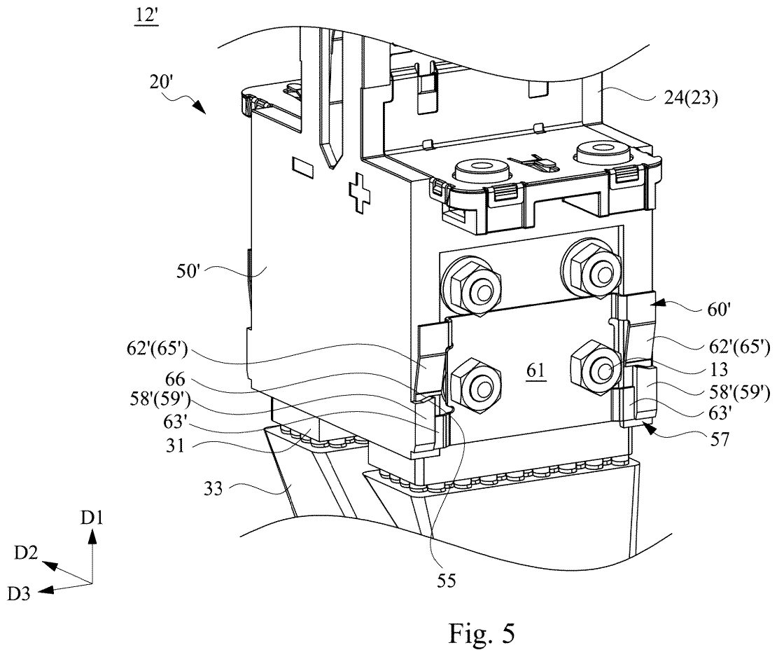

Reference is made to FIG. 5. FIG. 5 illustrates an axonometric view of a power connector 12′ in accordance with another embodiment of the present disclosure. The present embodiment differs from the previous embodiment in that: (1) the extension arms 63′ of the locking piece 60′ extend linearly and do not have any hook portion; and (2) the latches 65′ of the latch structure 62′ each have a leading edge 66 extending obliquely in a direction away from the mating portion 23, the bumps 59′ of the first stopper structure 58′ of the housing 20′ each have a sloping surface 55 corresponding to the leading edge 66, and the sloping surface 55 and the leading edge 66 have complementary shapes (i.e., the sloping surface 55 also extends obliquely in a direction away from the mating portion 23). The sloping surface 55 and the leading edge 66 can help strengthen the overall structure of the power connector 12′ and specifically, can prevent deformation of the two sidewalls 50′ when the electrode assemblies 30 (the first conductive block 31 in particular) are twisted.

As shown in FIG. 5, in some embodiments, in the first direction D1, the latch 65′ has a first length on a side adjacent to the base portion 61 and a second length on a side away from the base portion 61, and the second length is greater than the first length. Hence, the leading edge 66 tilts inwardly and tilts towards the first direction D1. Correspondingly, in the first direction D1, the bump 59′ has a third length on a side adjacent to the base portion 61 and a fourth length on a side away from the base portion 61, and the third length is greater than the fourth length. Hence, the sloping surface 55 tilts outwardly and tilts towards the first direction D1. When the electrode assembly 30 moves backwards (e.g., move in the opposite direction of the first direction D1), the sloping surface 55 causes the latch 65′ to deform outwards, which creates a restoring force that brings the electrode assembly 30 back in position.

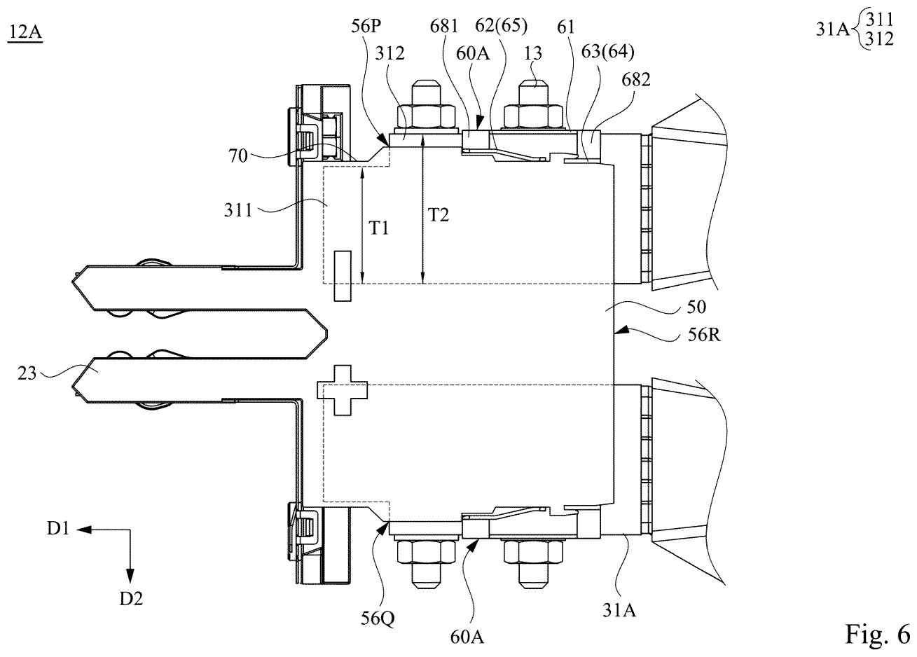

Reference is made to FIG. 6. FIG. 6 illustrates a schematic side view of a power connector 12A in accordance with another embodiment of the present disclosure. In the present embodiment, at least one of the first conductive blocks 31A has a portion protruding into or through the first side opening 56P or the second side opening 56Q (also see FIG. 3). Namely, at least one of the first conductive blocks 31A may include a first portion 311 and a second portion 312 connected to the first portion 311. The first portion 311 is located behind the short sidewall 70, and the second portion 312 is exposed from the first side opening 56P or the second side opening 56Q. A thickness T2 of the second portion 312 is greater than a thickness T1 of the first portion 311. In other words, the outer surface of the first conductive block 31A has a step at a location where the first portion 311 and the second portion 312 meet. By this arrangement, the first conductive block 31A can carry larger currents. When the second portion 312 of the first conductive block 31A protrudes from the first side opening 56P or the second side opening 56Q, the bent portion of the locking piece 60A (the bent portion 681 connected between the base portion 61 and the latch 65, or the bent portion 682 connected between the base portion 61 and the extension arm 63) is convex to accommodate the second portion 312 of the first conductive block 31A.

In sum, in the power connector of the present disclosure, each electrode assembly includes at least one terminal and a conductive block (e.g., a copper block) in contact with the terminal to widen the path of electric current and enable the power connector to carry larger current. As for the design of the housing, the main body of the housing only includes two sidewalls. The two sidewalls are normal to two standing walls of the mating portion. The two sidewalls are spaced apart from each other and are not interconnected by any partitioning wall (i.e., the space between the two electrode assemblies is void of any object that electrically isolates the two electrode assemblies). As a result, larger copper blocks can be placed in the housing, and the gap between the copper blocks of the two electrode assemblies can act as an airflow passage to facilitate cooling of the copper blocks and the terminals, which electric current flows through. A locking piece is attached to each copper block. The locking piece includes a latch structure that engages a corresponding stopper structure of the housing to prevent the copper blocks and the terminals from separating with the housing. The locking piece does not impose any limitation on the thickness of the copper block. Consequently, the thickness, and correspondingly, the current carrying capacity, of the copper block can be adjusted for different use cases freely.

Although the present disclosure has been described by way of the exemplary embodiments above, the present disclosure is not to be limited to those embodiments. Any person skilled in the art can make various changes and modifications without departing from the spirit and the scope of the present disclosure. Therefore, the protective scope of the present disclosure shall be the scope of the claims as attached.

What is claimed is:

1. A power connector, comprising:
two electrode assemblies each comprising at least one terminal and at least one busbar, the at least one terminal being fixedly attached to the at least one busbar;
a housing comprising two sidewalls and a mating portion, wherein the two sidewalls are spaced apart from each other and collectively define an accommodating space, the mating portion is connected to the two sidewalls and projects from one side of the two sidewalls, the mating portion defines a slot substantially normal to the two sidewalls, wherein the at least one busbar is disposed in the accommodating space, and the at least one busbar of a first electrode assembly of the two electrode assemblies is spaced apart from the at least one busbar of a second electrode assembly of the two electrode assemblies, wherein the at least one terminal partially extends into the slot of the mating portion; and
two locking pieces affixed to the busbars of the first electrode assembly and the second electrode assembly, respectively, wherein the two sidewalls each have at least one recess, and the two locking pieces fixedly engage the at least one recess of each of the two sidewalls.

2. The power connector of claim 1, wherein the two locking pieces each comprise a latch structure, the two sidewalls comprise a stopper structure, the stopper structure is located on a side of the latch structure away from the mating portion and engages the latch structure.

3. The power connector of claim 2, wherein the stopper structure has the at least one recess, and the at least one recess is formed on a side of the stopper structure away from the latch structure.

4. The power connector of claim 2, wherein the latch structure has a leading edge extending obliquely in a direction away from the mating portion, the stopper structure has a sloping surface corresponding to the leading edge of the latch structure, and the sloping surface and the leading edge have complementary shapes.

5. The power connector of claim 2, wherein the latch structure comprises a flexible arm structure extending in an oblique direction.

6. The power connector of claim 5, wherein the stopper structure comprises a bump, and the bump has a sloping surface extending in the oblique direction.

7. The power connector of claim 1, wherein the two sidewalls of the housing further define a first side opening and a second side opening, the first side opening and the second side opening are located on two opposite sides of the accommodating space, the two locking pieces extend across the first side opening and the second side opening, respectively, and fixedly engage each of the two sidewalls.

8. The power connector of claim 7, wherein the at least one recess of a first sidewall of the two sidewalls and the at least one recess of a second sidewall of the two sidewalls are located on two sides of the first side opening, wherein one of the two locking pieces comprises two extension arms, one of which is fixedly inserted into the at least one recess of the first sidewall and the other is fixedly inserted into the at least one recess of the second sidewall.

9. The power connector of claim 8, wherein the two extension arms each comprise a hook portion fixedly engaging the at least one recess.

10. The power connector of claim 1, wherein the two electrode assemblies keep a gap in between, the gap is void of any object that electrically isolates the two electrode assemblies, and the gap communicates with the slot to form an airflow passage.

11. The power connector of claim 1, wherein the at least one busbar of each of the two electrode assemblies comprises a first conductive block, a second conductive block and a braided conductive wire structure, the first conductive block is fixedly attached the at least one terminal, the second conductive block is disposed outside the housing, and the braided conductive wire structure is connected between the first conductive block and the second conductive block.

12. The power connector of claim 11, wherein the at least one terminal comprises a first terminal and a second terminal, the first terminal, the second terminal and the first conductive block are in a stack arrangement, wherein the first terminal and the second terminal each comprise a contact portion, the contact portion of the first terminal is positioned behind the contact portion of the second terminal in an extending direction of the mating portion.

13. The power connector of claim 12, wherein the contact portion of the first terminal is aligned with the contact portion of the second terminal in a third direction normal to the extending direction of the mating portion.

14. The power connector of claim 11, wherein an orientation of the first conductive block is normal to an orientation of the second conductive block.

15. The power connector of claim 11, wherein the mating portion comprises two standing walls spaced apart from each other, such that the slot is formed between the two standing walls, wherein an inner surface of the first conductive block of the first electrode assembly is substantially flush with an inner surface of one of the two standing walls, and an inner surface of the first conductive block of the second electrode assembly is substantially flush with an inner surface of another one of the two standing walls.

16. The power connector of claim 1, wherein the two sidewalls each have at least one guiding groove, the at least one guiding groove is located on inner surfaces of the two sidewalls and extends along an extending direction of the mating portion, and an edge of the at least one terminal is received by the at least one guiding groove.

17. The power connector of claim 1, wherein the two sidewalls each have a first edge, a second edge opposite to the first edge, and a third edge connected between the first edge and the second edge, wherein the at least one recess of each of the two sidewalls is plural in number, and the recesses of each of the two sidewalls are located on the first edge and the second edge.

18. The power connector of claim 1, wherein the recesses of the two sidewalls are located on inner surfaces of the two sidewalls.

19. The power connector of claim 1, wherein the at least one busbar comprises at least one copper busbar.

20. The power connector of claim 1, wherein the at least one busbar is plural in number, and the two locking pieces are fixed between two of the busbars.
